(19) United States
(12) Patent Application Publication
(10) Pub. No.: US 2014/0040909 A1
(43) Pub. Date: Feb. 6, 2014

(54) DATA PROCESSING SYSTEMS

(71) Applicants: Paul Winser, Bristol (GB); Ray McConnell, Bristol (GB)

(72) Inventors: Paul Winser, Bristol (GB); Ray McConnell, Bristol (GB)

(21) Appl. No.: 13/880,567

(22) PCT Filed: Oct. 20, 2011
(86) PCT No.: PCT/GB2011/052041

§ 371 Date: Oct. 23, 2013

(30) Foreign Application Priority Data
Oct. 21, 2010 (GB) 1017738.4
Oct. 21, 2010 (GB) 1017748.3
Oct. 21, 2010 (GB) 1017750.9
Oct. 21, 2010 (GB) 1017752.5

(51) Int. Cl. G06F 9/50

(52) U.S. Cl. CPC G06F 9/50
USPC 718/104

(57) ABSTRACT

A data processing system is described in which a plurality of data processing units 52₁ . . . 52_{N} cooperate with one another in order to process incoming data packets or an incoming data stream. Tasks are managed using a task list which is accessible and updateable by each data processing unit.

The present invention relates to data processing systems, for example for use in wireless communications systems.

### BACKGROUND OF THE INVENTION

A simplified wireless communications system is illustrated schematically in FIG. 1 of the accompanying drawings. A transmitter 1 communicates with a receiver 2 over an air interface 3 using radio frequency signals. In digital radio wireless communications systems, a signal to be transmitted is encoded into a stream of data samples that represent the signal. The data samples are digital values in the form of complex numbers. A simplified transmitter 1 is illustrated in FIG. 2 of the accompanying drawings, and comprises a signal input 11, a digital to analogue converter 12, a modulator 13, and an antenna 14. A digital datastream is supplied to the signal input 11, and is converted into analogue form at a baseband frequency using the digital to analogue converter 12. The resulting analogue signal is used to modulate a carrier waveform having a higher frequency than the baseband signal by the modulator 13. The modulated signal is supplied to the antenna 14 for transmission over the air interface 3.

At the receiver 2, the reverse process takes place. FIG. 3 illustrates a simplified receiver 2 which comprises an antenna 21 for receiving radio frequency signals, a demodulator 22 for demodulating those signals to baseband frequency, and an analogue to digital converter 23 which operates to convert such analogue baseband signals to a digital output datastream 24.

Since wireless communications device typically provide both transmission and reception functions, and that, generally, transmission and reception occur at different times, the same digital processing resources may be reused for both purposes.

In a packet-based system, the datastream is divided into ‘Data Packets’, each of which contains up to 100's of kilobytes of data. Each data packet generally comprises:

1. A Preamble, used by the receiver to synchronise its decoding operation to the incoming signal.

2. A Header, which contains information about the packet such as its length and coding style.

3. The Payload, which is the actual data to be transferred.

4. A Checksum, which is computed from the entirety of the data and allows the receiver to verify that all data bits have been correctly received.

Each of these data packet sections must be processed and decoded in order to provide the original datastream to the receiver. FIG. 4 illustrates that a packet processor 5 is provided in order to process a received datastream 24 into a decoded output datastream 58.

The different types of processing required by these sections of the packet and the complexity of the coding algorithms suggest that a software-based processing system is to be preferred, in order to reduce the complexity of the hardware. However, a pure software approach is difficult since each packet comprises a continuous stream of samples with no time gaps in between. As such, a pipelined hardware implementation may be preferred.

For multi-gigabit wireless communications, the baseband sample rate required is typically in the range of 1 GHz to over 5 GHz. This presents a problem when implementing the baseband processing in a digital device, since this sample rate is comparable to or higher than the clock rate of the processing circuits that are generally available. The number of processing cycles available per sample can then fall to a very low level, sometimes less than unity. Existing solutions to this problem have drawbacks as follows:

1. Run the baseband processing circuitry at high speed, equal to or greater than the sample rate: Operating CMOS circuits at GHz frequencies consumes excessive amounts of power, more than is acceptable in small, low-power, battery-operated devices. The design of such high frequency processing circuits is also very labour-intensive.

2. Decompose the processing into a large number of stages and implement a pipeline of hardware blocks, each of which perform only one section of the processing: Moving all the data through a large number of hardware units uses considerable power in the movement, in addition to the power consumed in the actual processing itself. In addition, the functions of the stages are quite specific and so flexibility in the processing algorithms is lost.

Existing solutions make use of a combination of (1) and (2) above to achieve the required processing performance.

An alternative approach is one of parallel processing; that is to split the stream of samples into a number of slower streams which are processed by an array of identical processor units, each operating at a clock frequency low enough to ease their design effort and avoid excessive power consumption. However, this approach also has drawbacks. If too many processors are used, the hardware overhead of instruction fetch and issue becomes undesirably large, and, therefore, inefficient. If processors are arranged—together into a Single Instruction Multiple data (SIMD) arrangement, then the latency of waiting for them to fill with data can exceed the upper limit for latency, as specified in the protocol standard being implemented.

An architecture with multiple processors communicating via shared memory can have the problem of contention for a shared memory resource. This is a particular disadvantage in a system that needs to process a continual stream of data and cannot tolerate delays in processing.

### SUMMARY OF THE INVENTION

According to one aspect of the present invention, there is provided a data processing system comprising a control unit, a plurality of data processing units, a shared data storage device operable to store data for each of the plurality of data processing units, and to store a task descriptor list accessible by each of the data processing units, and a bus system connected for transferring data between the data processing units, wherein the data processing units each comprise a scalar processor device, and a heterogeneous processor device connected to receive instruction information from the scalar processor, and to receive incoming data, and operable to process incoming data in accordance with received instruction information, the heterogeneous processor device comprising a heterogeneous controller unit connected to receive instruction information from the scalar processor, and operable to output instruction information, an instruction sequencer connected to receive instruction information from the heterogeneous controller unit, and operable to output a sequence of instructions, and a plurality of heterogeneous function units, including a vector processor array including a plurality of vector processor elements operable to process received data items in accordance with instructions received from the instruction sequencer, a low-density parity-check (LDPC) decode accelerator unit connected to receive encoded data items from the vector processor array, and operable, under control of the heterogeneous controller unit, to decode such received data items and to transmit decoded data items to the vector processor array, and a fast Fourier transform (FFT) accelerator unit connected to receive encoded data items from the vector processor array, and operable, under control of the heterogeneous controller unit, to decode such received data items and to transmit decoded data items to the vector processor array, wherein each data processing unit is operable to access a task descriptor list stored in the shared storage device, to retrieve a task descriptor in such a task descriptor list, and to update that task descriptor in the task descriptor list in dependence upon a state of execution of a task described by the task descriptor.

In one example, the data processing units are operable to execute tasks described by retrieved task descriptors substantially simultaneously in predefined processing phases.

In one example, each data processing unit is operable to transfer a modified task descriptor to another data processing unit by modifying that task descriptor in the task descriptor list.

In one example, the data processing units are operable to execute respective different tasks defined by task descriptors retrieved from the task descriptor list.

Each data processing unit may be operable to enter a low power mode upon completion of a task defined by a task descriptor retrieved from the task list. In such a case, each data processing unit may be operable to be caused to exit the low power mode upon initiation of a processing phase.

In one example, the bus system provides a data input network, a data output network, and a shared memory network.

The data processing system may receive a substantially continual stream of data items at an incoming data rate, and the plurality of data processing units can then be arranged to process such a stream of data items, such that each of the data processing units is substantially continually utilised.

According to another aspect of the present invention, there is provided a method of processing an incoming data stream using such a data processing system, the method comprising receiving instruction information, defining a task descriptor from the instruction information, defining a task descriptor list accessible by each of the data processing units, storing the task descriptor in the task descriptor list, accessing the task descriptor list to retrieve a task descriptor stored therein, and updating that task descriptor in the task descriptor list in dependence upon a state of execution of a task described by the task descriptor.

In embodiments of the present invention, a single task of processing a stream of wireless data is broken into discrete ‘processing phases’ where each processing phase is executed on a physical processing unit. Multiple physical processing units are able to execute successive phases overlapped and in parallel, and the number of physical processing units can be scaled according to the time taken to execute each phase, such that sufficient physical processing units are provided to process a continuous stream of data.

In some examples, tasks are not static but may have their descriptors modified by the results of any processing stage.

Unlike other multiprocessor task allocation schemes which seek to allocate processing resources efficiently and fairly to a number of available tasks, example embodiments of the present invention are able to provide a structure for applying multiple processing resources to a single task, such that different data sections of that task may be processed in parallel on multiple processors, and where results of one processing phase may be passed to another processor to be included in subsequent phases.

Unlike other multiprocessing schemes where processors actively fetch tasks from a shared task store, in example embodiments of the present invention, a processor enters a passive low power state from which it exits only when it is allocated a task by another processor or entity in the system.

### BRIEF DESCRIPTION OF THE DRAWINGS

FIG. 1 is a simplified schematic view of a wireless communications system;

FIG. 2 is a simplified schematic view of a transmitter of the system of FIG. 1;

FIG. 3 is a simplified schematic view of a receiver of the system of FIG. 1;

FIG. 4 illustrates a data processor;

FIG. 5 illustrates a data processor including processing units embodying one aspect of the present invention;

FIG. 6 illustrates data packet processing by the data processor of FIG. 5;

FIG. 7 illustrates a processing unit embodying one aspect of the present invention for use in the data processor of FIG. 5;

FIG. 8 illustrates a method embodying another aspect of the present invention;

FIG. 9 illustrates steps in a method related to that shown in FIG. 8;

FIG. 10 illustrates the processing unit of FIG. 7 in more detail;

FIG. 11 illustrates a scalar processing unit and a heterogeneous controller unit of the processing unit of FIG. 10;

FIG. 12 illustrates a controller of the heterogeneous controller unit of FIG. 11; and

FIGS. 13a and 13b illustrate data processing according to another aspect of the present invention, performed by the processing unit of FIGS. 10 to 12.

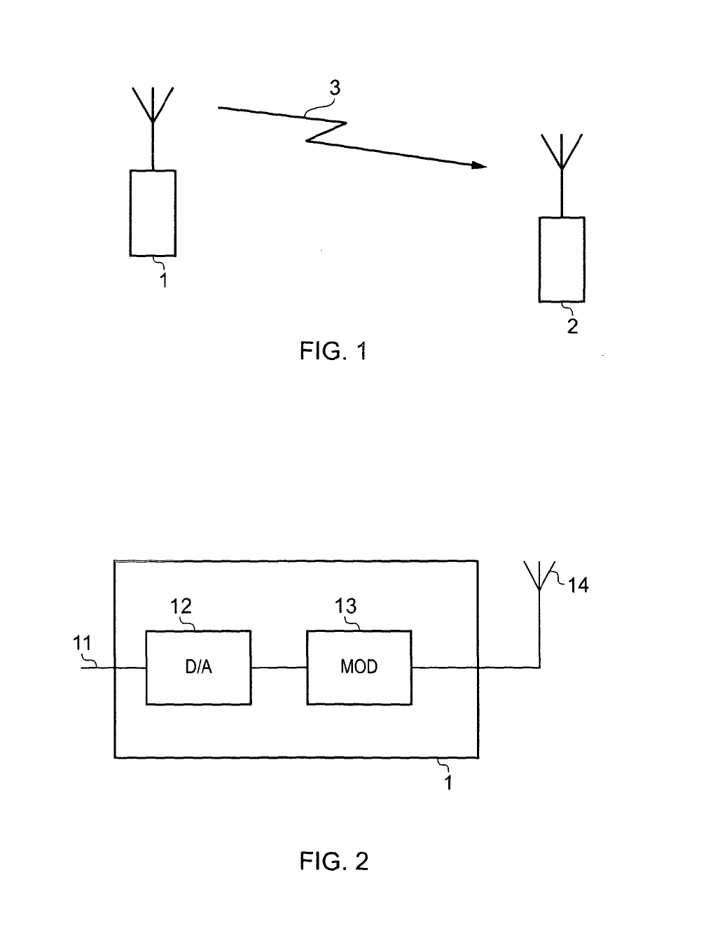

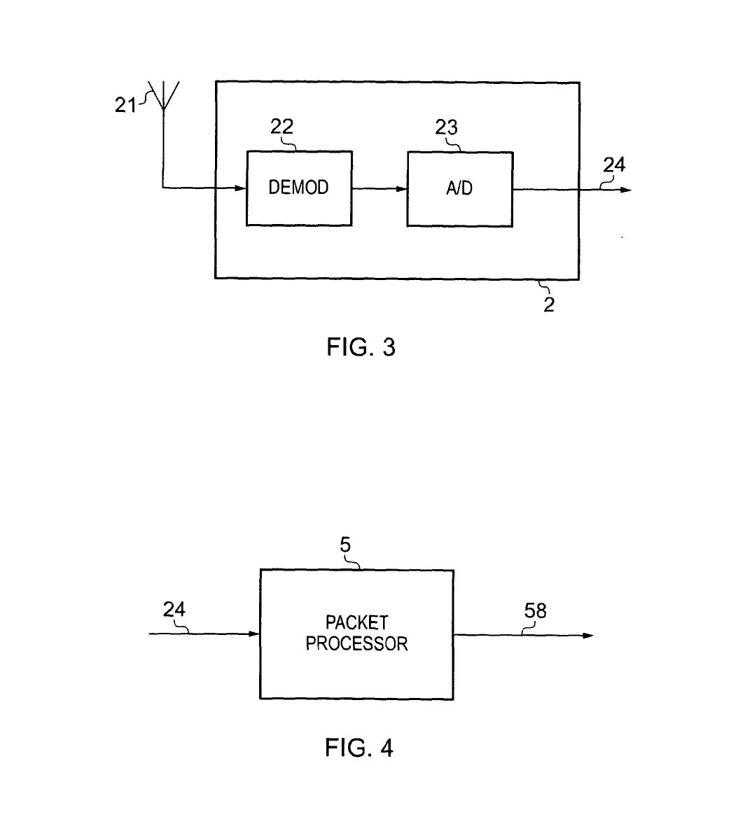

### DETAILED DESCRIPTION OF THE PREFERRED EMBODIMENTS

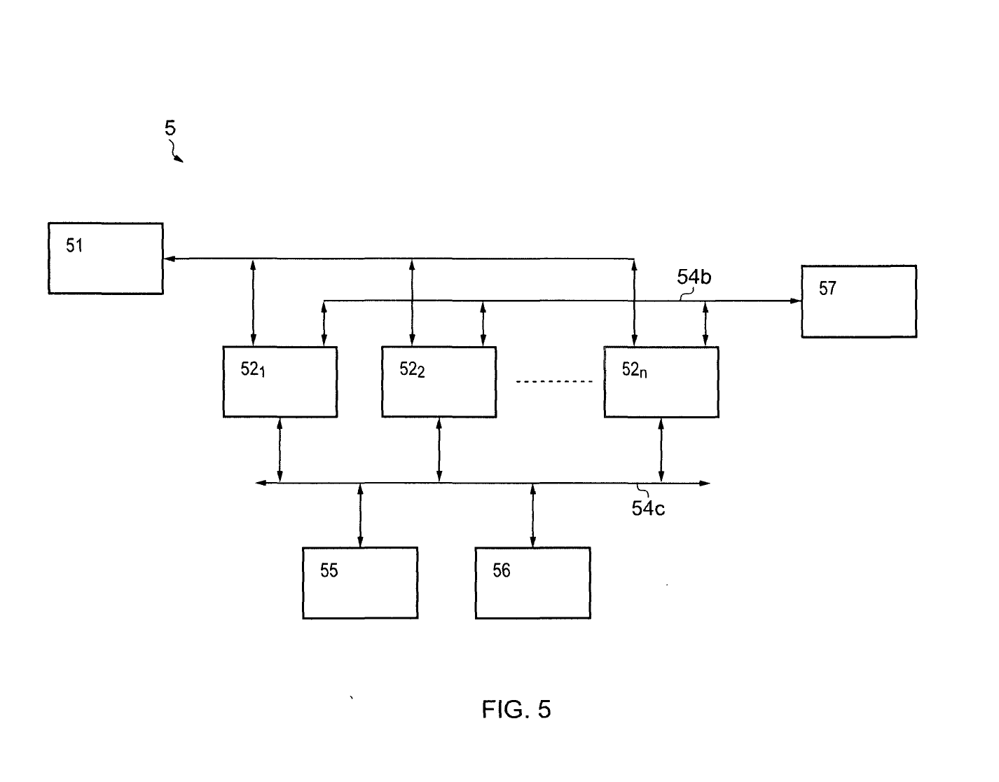

FIG. 5 illustrates a data processor which includes a processing unit embodying one aspect of the present invention. Such a processor is suitable for processing a continual datastream, or data arranged as packets. Indeed, data within a data packet is also continual for the length of the data packet, or for part of the data packet.

The processor 5 includes a cluster of N data processing units (or “physical processing units”) 52₁ . . . 52_{N}, hereafter referred to as “PPUs”. The PPUs 52₁ . . . 52_{N} receive data from a first data unit 51, and sends processed data to a second data unit 57. The first and second data units 51, 57 are hardware blocks that may contain buffering or data formatting or timing functions. In the example to be described, the first data unit 51 is connected to transfer data with the radio sections of a wireless communications device, and the second data unit is connected to transfer data with the user data processing sections of the device. It will be appreciated that the first and second data units 51, 57 are suitable for transferring data to be processed by the PPUs 52 with any appropriate data source or data sink. In the present example, in a receive mode of operation, data flows from the first data unit 51, through the processor array to the second data unit 57. In a transmit mode of operation, the data flow is in the opposite direction—that is, from the second data unit 57 to the first data unit 51 via that processing array.

The PPUs 52₁ . . . 52_{N} are under the control of a control processor 55, and make use of a shared memory resource 56. Data and control signals are transferred between the PPUs 52₁ . . . 52_{N}, the control processor 55, and the memory resource 56 using a bus system 54c.

It can be seen that the workload of processing a data stream from source to destination is divided N ways between the PPUs 52₁ . . . 52_{N} on the basis of time-slicing the data. Each PPU then needs only 1/Nth of the performance that a single processor would have needed. This translates into simpler hardware design, lower clock speed, and lower overall power consumption. The control processor 55 and shared memory resource 56 may be provided in the device itself, or may be provided by one or more external units.

The control processor 55 has different capabilities to the PPUs 52₁ . . . 52_{N}, since its tasks are more comparable to a general purpose processor running a body of control software. It may also be a degenerate control block with no software. It may therefore be an entirely different type of processor, as long as it can perform shared memory communications with the PPUs 52₁ . . . 52_{N}. However, the control processor 55 may be simply another instance of a PPU, or it may be of the same type but with minor modifications suited to its tasks.

It should be noted that the bandwidth of the radio data stream is usually considerably higher than the unencoded user data it represents. This means that the first data unit 51, which is at the radio end of the processing, operates at high bandwidth, and the second data unit 57 operates at a lower bandwidth related to the stream of user data.

At the radio interface, the data stream is substantially continual within a data packet. In the digital baseband processing, the data stream does not have to be continual, but the average data rate must match that of the radio frequency datastream. This means that if the baseband processing peak rate is faster than the radio data rate, the baseband processing can be executed in a non-continual, burst-like fashion. In practise however, a large difference in processing rate will require more buffering in the first and second data units 51, 57 in order to match the rates, and this is undesirable both for the cost of the data buffer storage, and the latency of data being buffered for extended periods. Therefore, baseband processing should execute as near to continually as possible, and at a rate that needs to be only slightly faster than the rate of the radio data stream, in order to allow for small temporal gaps in the processing.

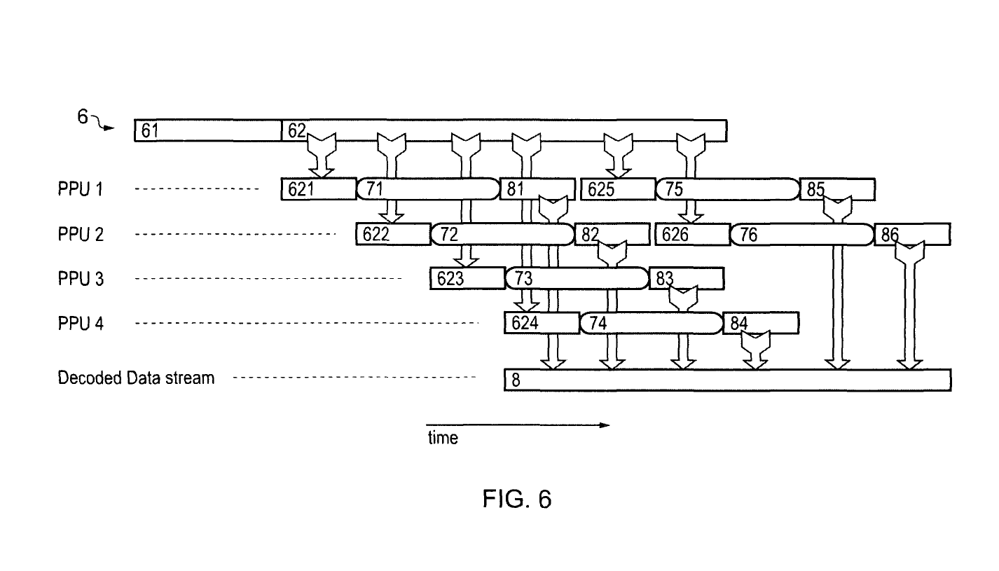

In the context of FIG. 5, this means that data should be near-continually streamed either to or from the radio end of the processing (to and from the first data unit 51). In a receive mode, the high bandwidth stream of near-continual data is time sliced between the PPUs 52₁ . . . 52_{N}. Consider the receiving case where high bandwidth radio sample data is being transferred from the first data unit 51 to the PPU cluster: In the simple case, a batch of radio data, being a fixed number of samples, is transferred to each PPU in turn, in round-robin sequence. This is illustrated for a received packet in FIG. 6, for the case of a cluster of four PPUs.

Each PPU 52₁ . . . 52_{N} receives 621, 622, 623, 624, 625, and 626 a portion of the packet data 62 from the incoming data stream 6. The received data portion is then processed 71, 72, 73, 74, 75, and 76, and output 81, 82, 83, 84, 85, and 86 to form a decoded data packet 8.

Each PPU 52₁ . . . 52_{N} must have finished processing its previous batch of samples by the time it is sent a new batch. In this way, all N PPUs 52₁ . . . 52_{N} execute the same processing sequence, but their execution is ‘out of phase’ with each other, such that in combination they can accept a continuous stream of sample data.

In this simple receive case described above, each PPU 52₁ . . . 52_{N} produces decoded output user data, at a lower bandwidth than the radio data, and supplies that data to the second data unit 57. Since the processing is uniform, the data output from all N PPUs 52₁ . . . 52_{N} arrives at the data sink unit 57 in the correct order, so as to produce a decoded data packet.

In a simple transmit mode case, this arrangement is simply reversed, with the PPUs 52₁ . . . 52_{N} accepting user data from the second data unit 57 and outputting encoded sample data to the first data unit 51 for radio transmission.

However, wireless data processing is more complex than in the simple case described above. The processing will not always be uniform—it will depend on the section of the data packet being processed, and may depend on factors determined by the data packet itself. For example, the Header section of a received packet may contain information on how to process the following payload. The processing algorithms may need to be modified during reception of the packet in response to degradation of the wireless signal. On the completion of receiving a packet, an acknowledgement packet may need to be immediately transmitted in response. These and other examples of more complex processing demand that the PPUs 52₁ . . . 52_{N} have a flexibility of scheduling and operation that is driven by the software running on them, and not just a simple pattern of operation that is fixed in hardware.

Under this more complex processing regime, the following considerations must be taken into account:
A control process, thread or agent defines the overall tasks to be performed. It may modify the priority of tasks depending on data-driven events. It may have a list of several tasks to be performed at the same time, by the available PPUs 52₁ . . . 52_{N} of the cluster.

The data of a received packet is split into a number of sections. The lengths of the sections may vary, and some sections may be absent in some packets. Furthermore, the sections often comprise blocks of data of a fixed number of samples. These blocks of sample data are termed ‘Symbols’ in this description. It is highly desirable that all the data for any symbol be processed in its entirety by one PPU 52₁ . . . 52_{N} of the cluster, since splitting a symbol between two PPUs 52₁ . . . 52_{N} would involve undue communication between the PPUs 52₁ . . . 52_{N} in order to process that symbol. In some cases it is also desirable that several symbols be processed together in one PPU 52₁ . . . 52_{N}, for example if the Header section 61 (FIG. 6) of the data packet comprises several symbols. The PPUs 52₁ . . . 52_{N} must in general therefore be able to dictate how much data they receive in any given processing phase from the data source unit 51, since this quantity may need to vary throughout the processing of a packet.
Non-uniform processing conditions could potentially result in out of order processed data being available from the PPUs 52₁ . . . 52_{N}. In order to prevent such possibility, a mechanism is provided to ensure that processed data are provided to the first data unit 51 (in a transmit mode) or to the second data unit 57 (in a receive mode), in the correct order.
The processing algorithms for one section of a data packet may depend on previous sections of the data packet. This means that PPUs 52₁ . . . 52_{N} must communicate with each other about the exact processing to be performed on subsequent data. This is in addition to, and may be a modification of, the original task specified by the control process, thread, or agent.
The combined processing power of the entire N PPUs 52₁ . . . 52_{N} in the cluster must be at least sufficient for handling the wireless data stream in that mode that demands the greatest processing resources. In some situations, however, the data stream may require a lighter processing load, and this may result in PPUs 52₁ . . . 52_{N} completing their processing of a data batch ahead of schedule. It is highly desirable that any PPU 52₁ . . . 52_{N} with no immediate work load to execute be able to enter an inactive, low-power ‘sleep’ mode, from which it can be awoken when a workload becomes available.

The cluster arrangement provides the software with the ability for each of the PPUs 52₁ . . . 52_{N} in the cluster to collectively decide the optimal DSP algorithms and modes in which the system should be placed in. This reduction of the collective information is available to the control processor via the SCN network. This localised processing and decision reduction allows the control processor to view the PPU cluster as a single logical entity.

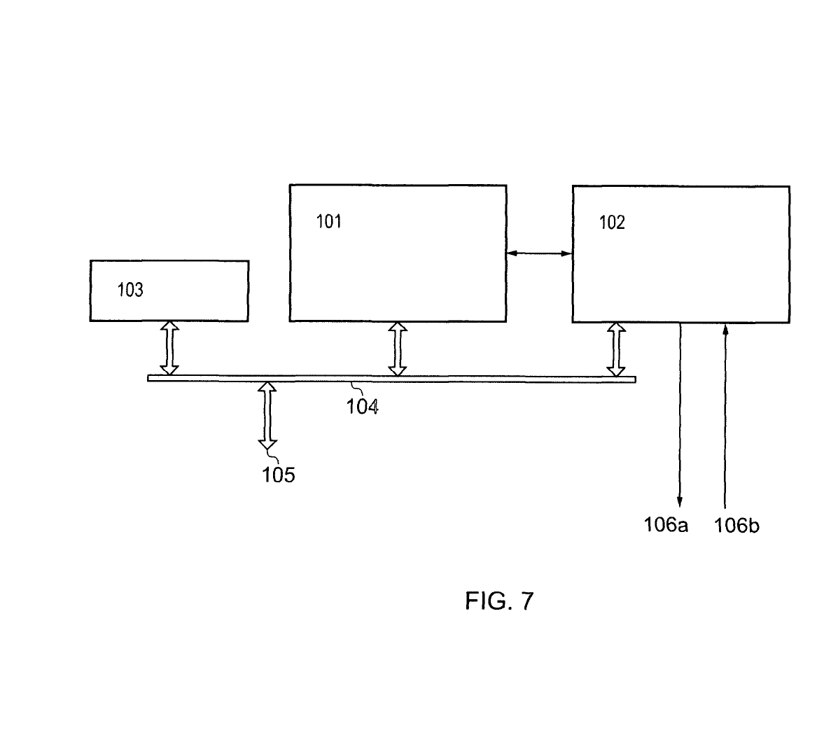

A PPU is illustrated in FIG. 7, and comprises scalar processor unit 101 (which could be a 32-bit processor) closely connected with a heterogeneous processor unit (HPU) 102. High bandwidth real time data is coupled directly into and out of the HPU 102, via a system data network (SDN) 106a and 106b (54a and 54b in FIG. 5). Scalar processor data and control data are transferred using a PPU-SMP (PPU-symmetrical multiprocessor) network PSN 104, 105 (54c in FIG. 5). A local memory device 103 is provided for access by the scalar processor unit 101, and by the heterogeneous processor unit 104.

The data processor includes hierarchical data networks which are designed to localise high bandwidth transactions and to maximise bandwidth with minimal data latency and power dissipation. These networks make use of an addressing scheme which is common to both the local data storage and to processor wide data storage, in order to simplify the programming model.

Data are substantially continually dispatched, in real time, into the HPU 102, in sequence via the SDN 106a, and are then processed. Processed data exit from the HPU 102 on the SDN 106b.

The scalar processor unit 101 operates by executing a series of instructions defined in a high level program. Embedded in this program are specific coprocessor instructions that are customised for computation within the HPU 102.

A task-based scheduling scheme embodying one aspect of the present invention is shown in

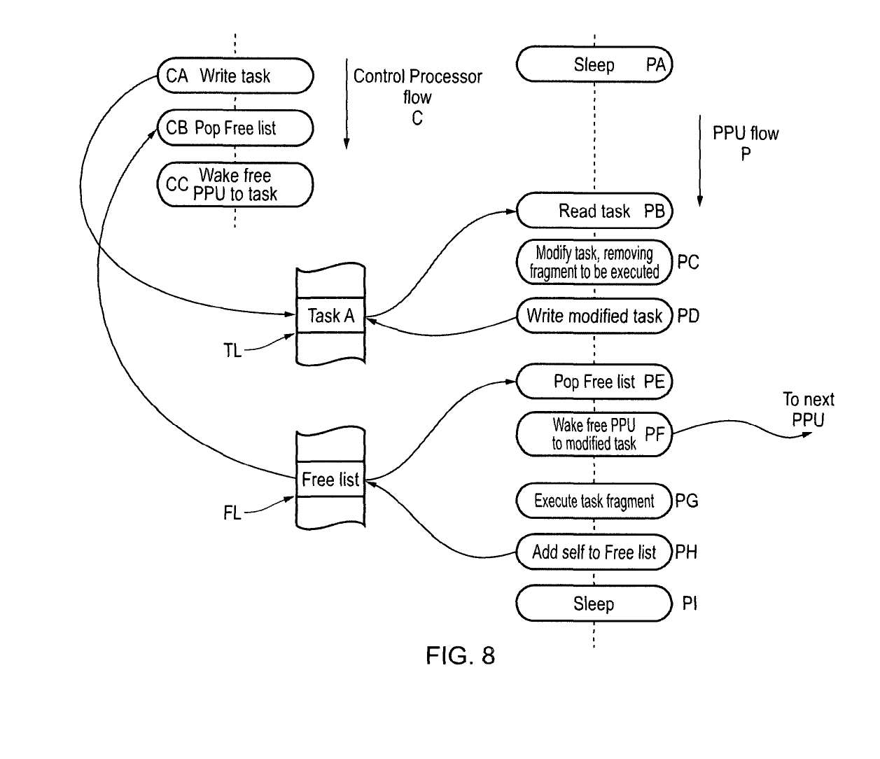

FIG. 8, which shows the sequence of steps in the case of a PPU 52₁ . . . 52_{N} being allocated a task by the control processor 55. The operation of a second PPU 52₁ . . . 52_{N} executing a second fragment of the task, and so on, is not shown in this simplified diagram.

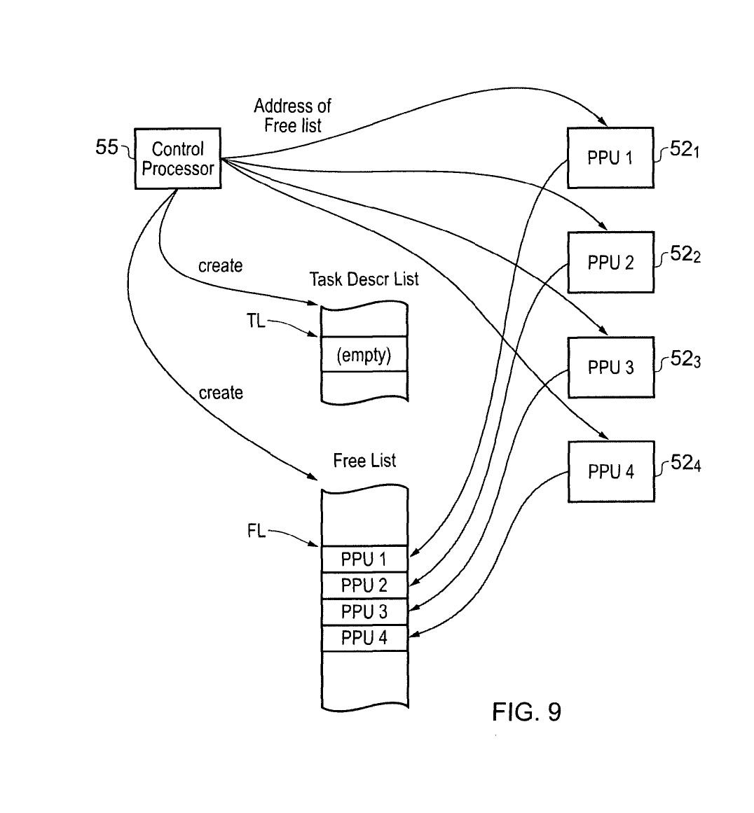

Two lists are defined in the shared memory resource 56. Each list is accessible by each of the PPUs 52₁ . . . 52_{N} and by the control processor 55 for mutual communications. FIG. 9 illustrates initialisation steps for the two lists, and shows the state of each list after initialisation of the system. The control processor 55 creates a task descriptor list TL and a free list FL in shared memory. Both lists are created empty. The task descriptor list TL is used to hold task information for access by the PPUs 52₁ . . . 52_{N}, as described below. The free list FL is used to provide information regarding free processing resources.

The control processor initiates each PPU belonging to the cluster with the address of the free list FL, which address the PPUs 52₁ . . . 52_{N} need in order to participate in the task sharing scheme. Each PPU 52 then adds itself on to the Free List FL, in no particular order.

Specifically, a PPU 52 appends the free list FL with an entry containing the address of the PPU's wake-up mechanism. After adding itself to the free list, a PPU can enter a low-power sleep state. It can be subsequently be awoken, for example by another PPU, by the control processor, or by another processor, to perform a task by the writing of the address of a task descriptor to the address of the PPU's wake-up mechanism.

Management of lists in memory—creation, appending and deleting items is a well-known technique in software engineering and the details of the implementation are not described here, for the sake of clarity.

Referring back to FIG. 8, items on the task descriptor list TL represent work that is to be done by the PPUs 52₁ . . . 52_{N}. The free list FL allows the PPUs 52₁ . . . 52_{N} to ‘queue up’ to be allocated tasks by the control processor 55.

Generally, a task represents too much work for a single PPU 52₁ . . . 52_{N} to complete in a single processing phase. For example, a task could cause a single PPU 52₁ . . . 52_{N} to consume more data than it can contain, or at least so much that the continuous compute and I/O operations depicted in FIG. 6 would be prevented. For this reason, a PPU 52₁ . . . 52_{N} that has been allocated a task will remove PB a task descriptor from the task descriptor list TL, but then return PD a modified task descriptor to the task descriptor list TL. The PPU 52 modifies the task descriptor to show that a processing phase has been accounted for by the PPU concerned, and to represent any remaining processing phases for the task in hand. The PPU also then allocates PF any remaining processing phases of the task to another PPU 52₁ . . . 52_{N} that is at the head of the free list FL. In other words, the first PPU 52₁ . . . 52_{N} takes PB a task descriptor from the task descriptor list TL, modifies PC the task descriptor to remove from it the work that it is going to do or has done, and then returns PD a modified task descriptor to the task descriptor list TL for another PPU 52₁ . . . 52_{N} to pick up and continue. This process may repeat any number of times before the task is finally fully completed. Whenever a PPU 52₁ . . . 52_{N} completes a task, or a phase of it, it adds itself PH to the free list FL so that it is available to be allocated a new task either by the control processor 55 or by another PPU 52₁ . . . 52_{N}. It may also update the task descriptor in the task descriptor list to indicate that the overall task has been completed (or is close to completion), along with any other relevant information such as the timestamp of completion or any errors that were encountered in processing. The PPU 52 that completes the final processing phase for a given task may signal the control processor directly to indicate the completion of the task. As an alternative, a PPU prior to the final PPU for a task can indicate the expectation of completion of the task, in order that the control processor is able to schedule the next task at an appropriate time to ensure that all of the processing resources are kept busy.

It should be noted that in this scheme, after the initial allocation of a task to a free PPU52₁ . . . 52_{N}, the control processor 55 is not involved in subsequent handover of the task to other PPUs for completion of the task. Indeed the order in which physical PPUs 52₁ . . . 52_{N} get to work on a task is determined purely by their position on the Free list FL, which in turn depends on when they completed their previous task phase. In the case of uniform processing as depicted in FIG. 6, it can be seen that a ‘round-robin’ order of processing between the PPUs 52₁ . . . 52_{N} naturally emerges, without being explicitly orchestrated by the control processor 55.

In the scheme described, a more general case of non-uniform processing automatically allocates free PPU 52₁ . . . 52_{N} resources to available tasks as they become available. The list mechanism supports simultaneous execution of multiple tasks—the control processor 55 can create any number of tasks on the task descriptor list TL and allocate a number of them to PPUs 52₁ . . . 52_{N}, up to a maximum number being the number of PPUs 52₁ . . . 52_{N} on the free list FL at that time. In order to avoid undesirable delays in waiting for a PPU 52₁ . . . 52_{N} to be free, the system is preferably designed with sufficient number of PPUs 52₁ . . . 52_{N}, each with sufficient processing power, so that there is always at least one PPU 52₁ . . . 52_{N} on the free list

FL during processing of a single task. Such provision ensures that the hand-off to the next PPU does not cause a delay in the processing of the current PPU. In an alternative technique, the current PPU can handover the next processing phase at an appropriate point relative to its own processing phase—that is before, during, or after the current processing phase.

Furthermore, the control processor 55 does not need to know how many PPUs 52₁ . . . 52_{N} there are in the cluster, since it only sees them in terms of a queue of available processing resources. This permits PPUs 52₁ . . . 52_{N} to join or leave dynamically the cluster without explicit interaction with the control processor 55. This may be advantageous for means of fault-tolerance or power management where one or more PPUs 52₁ . . . 52_{N} may leave the cluster either permanently or for long durations where it is known that the overall processing load will be light.

In the scheme described, PPUs 52₁ . . . 52_{N} are passively allocated tasks by another PPU 52₁ . . . 52_{N}, or the control processor 55. An alternative scheme has free PPUs actively monitoring the Task list TL for new tasks to arrive. However, the described scheme is preferable since it has the advantage that idle PPUs 52₁ . . . 52_{N} can be deactivated into an inactive, low power state, from which it is awoken by the agent allocating it a new task. Such an inactive state would be difficult to achieve if the PPU 52₁ . . . 52_{N} was actively seeking a new task by itself.

The basic interaction scheme described above can be extended to include additional functions. For example, PPUs 52₁ . . . 52_{N} may need to interact with each other to exchange information and to ensure that their input and output data portions are transferred in the correct order to and from the first and second data units 51 and 57. Such interactions could be direct between PPUs, or via shared memory either as additional fields in the task descriptor or as separate data structures.

It may be seen that interaction with the two memory based lists of the described scheme may itself consume some time, which represents undesirable delay and may require extra buffering of data streams. This can be minimised by PPUs 52₁ . . . 52_{N} negotiating their next task ahead of when that task can actually start execution. Thus, the time taken to manage the task list can be overlapped with the processing of a previous task item. This represents another elaboration of the scheme using handshake operations.

Another option for speeding up inter-processor communications is for each PPU 52₁ . . . 52_{N} to locally cache contents of the shared memory 56 such as the list structures described above, and for conventional cache coherency mechanisms to keep each PPU's local copy of the data synchronised with the others.

A task that is defined by the control processor 55 will typically consist of several sub-tasks. For example, to decode a received data packet, firstly the packet header must be decoded to determine the length and style of encoding of the following payload. Then, the payload itself must be decoded, and finally a checksum field will be compared to that calculated during decoding of the packet to check for any errors in the decoding process. This whole process will generally take many processing phases, with each phase being executed on a different PPU 52₁ . . . 52_{N} according to the Free list FL mechanism described above. In each processing phase, the PPU 52₁ . . . 52_{N} executing the task must modify the task description so that the next PPU 52₁ . . . 52_{N} can perform the correct sub-task or part thereof.

An example would be in the decoding of the data payload part of a received packet. The length of the payload is specified in the packet header. The PPU 52₁ . . . 52_{N} which decodes the header can insert the payload length into the modified task list entry, which is then passed to the next PPU52₁ . . . 52_{N}. That second PPU 52₁ . . . 52_{N} will in turn subtract the amount of payload data that it will decode during its processing phase from the task description before passing the task on to a third PPU52₁ . . . 52_{N}. This sequence continues until a PPU 52₁ . . . 52_{N} can complete decoding of the final section of the payload.

To continue the above example, the PPU 52₁ . . . 52_{N} that completes payload data decoding may then modify the task entry so that the next PPU 52₁ . . . 52_{N} performs the checksum processing. For this to be possible, each PPU 52₁ . . . 52_{N} that performs partial decoding of the payload data must also append the ‘running total’ result of the checksum calculation to the modified task list. The checksum running total is therefore passed along the processing sequence, via the task descriptor, so that the PPU 52₁ . . . 52_{N} that performs the final check has access to the total checksum calculation of the whole payload. Other items of information may be similarly appended to the task descriptor on a continuous basis, such as signal quality metrics.

In some cases, the actual processing to be performed will be directed by the content of the data. An obvious case is that the header of a received packet specifies the modulation and coding scheme of the following payload. The header will also typically contain the source and destination addresses of the packet. If the receiver is not the addressed destination device, or does not lie on a valid route towards the destination address, then the remainder of the packet, i.e. the payload, may be ignored instead of decoded. This represents an early termination of a task, rather than a modification of a task, and can achieve considerable overall power savings in a network consisting of many devices.

Information gained in the payload decoding process may also cause processing to be modified. For example, if received signal quality is poor, more sophisticated algorithms may be required to recover the data correctly. If a PPU 52₁ . . . 52_{N} identifies a change to the processing algorithms required, it can communicate that change to subsequent PPUs 52₁ . . . 52_{N} dealing with subsequent portions of the packet, again by passing such information through the task descriptor list TL in shared memory.

Many such decisions about processing methods may be taken individually by one PPU 52₁ . . . 52_{N} and communicated to subsequent processing phases. Alternatively, such decisions may be made cooperatively by several or all PPUs 52₁ . . . 52_{N} communicating via shared memory structures outside of the task descriptor list TL. This would typically be used for changes that occur due to longer-term effects and need many individual data points to be combined for decision making. Overall processing policies such as error protection or power management may be folded in to the collective decision making process. This may be performed entirely by the PPUs, or also involve the control processor 55.

In a receive mode, the function of the first data unit 51 is to distribute the incoming data stream to the PPUs 52₁ . . . 52_{N}. The amount of data that a PPU 52₁ . . . 52_{N} requires for any processing phase is known to the PPU 52₁ . . . 52_{N} and may depend on previous processing of packet data. Therefore, the PPU 52₁ . . . 52_{N} must request a defined amount of data from the first data unit 51, which then streams the requested amount of data back to the requesting PPU 52₁ . . . 52_{N}. The first data unit 51 should be able to deal with multiple requests for data arriving from PPUs 52₁ . . . 52_{N} in quick succession. It contains a request queue of depth equal to the number of PPUs 52₁ . . . 52_{N} or more. It executes each request in the order received, as data becomes available to it to service the requests.

Again in the receive mode, the function of the second data unit 57 is simply to combine the output data produced by each processing phase on a PPU52₁ . . . 52_{N}. Each PPU 52₁ . . . 52_{N} will in turn stream its output data to the data sink unit over the output data bus. In the case of non-uniform processing, it might be possible that output data from two PPUs arrives at the data sink in an incorrect order. To prevent this, the PPUs 52₁ . . . 52_{N} may exchange a software ‘token’ via shared memory that can be used to force serialisation of output data to the data sink in the correct order.

Both requesting data from the first data unit 51 and negotiating access to the second data unit 57 could add unwanted delay to the execution of a PPU processing phase. Both of these operations can be performed in advance, and overlapped with other processing in a ‘pipelined’ manner to avoid such delays.

For a transmit mode, the functions of the first and second data units are reversed, with the second data unit 57 supplying data for processing, and the first data unit 51 receiving processed data for transmission.

From the foregoing, it will be appreciated that in embodiments of the present invention, a single task of processing a stream of wireless data is broken into discrete ‘processing phases’ where each processing phase is executed on a physical processing unit. Multiple physical processing units are able to execute successive phases overlapped and in parallel, and the number of physical processing units can be scaled according to the time taken to execute each phase, such that sufficient physical processing units are provided to process a continuous stream of data.

In some examples, tasks are not static but may have their descriptors modified by the results of any processing stage.

Unlike other multiprocessor task allocation schemes which seek to allocate processing resources efficiently and fairly to a number of available tasks, example embodiments of the present invention are able to provide a structure for applying multiple processing resources to a single task, such that different data sections of that task may be processed in parallel on multiple processors, and where results of one processing phase may be passed to another processor to be included in subsequent phases.

Unlike other multiprocessing schemes where processors actively fetch tasks from a shared task store, in example embodiments of the present invention, a processor enters a passive low power state from which it exits only when it is allocated a task by another processor or entity in the system.

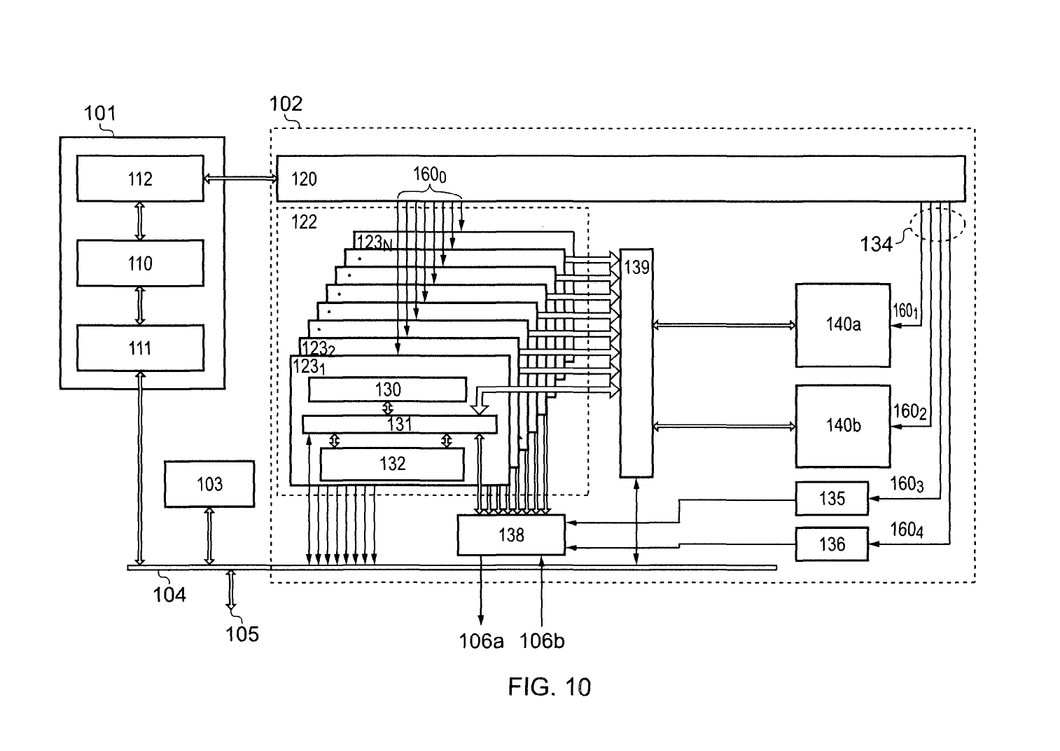

FIG. 10 illustrates the processing unit of FIG. 7 in more detail. The scalar processor unit 101 comprises a scalar processor 110, a data cache 111 for temporarily storing data to be transferred with the PU-SMP network 104, 105, and a co-processor interface 112 for providing interface functions to the heterogeneous processor unit 102.

The HPU 102 comprises the heterogeneous controller unit (HCU) 120 for directly controlling a number of heterogeneous function units (HFUs) and a number of connected hierarchical data networks. The total number of HFUs in the HPU 102 is scalable depending on required performance. These HFUs can be replicated, along with their controllers, within the HPU to reach any desired performance requirement.

As previously described the PPUs 52₁ . . . 52_{N}. have a need to inter communicate, in real time as the high speed data stream is received. The SU 101 in the PPU 52₁ . . . 52_{N} is responsible for this communication, which is defined in a high level C program. This communication also requires a significant computational load as each SU 101 needs to calculate parameters that are used in the processing of the data stream. The SU 101 has DSP instructions that are used extensively for this task. These computations are executed in parallel alongside the much heavier dataflow computations in the HPU 102.

As a consequence, the SU 101 in the PPU 52₁ . . . 52_{N} cannot service the low latency and computational burden of sequencing an instruction flow of the HPU 102. This potentially presents a requirement to add yet another SU 101 unit in the PPU 52₁ . . . 52_{N} to provide this function at a considerable extra power and area cost. However considerable effort has been expended to provide a low cost solution and the elimination of this extra SU unit is the benefit the HCU 120 provides, without loss of functionality and programmability.

The HCU therefore represents a highly optimised implementation of the required function that an integrated control processor would provide, but without the power and area overheads.

In this way the PPU 52₁ . . . 52_{N} can be seen as an optimised and scalable control and data plane processor for the PHY of a multi gigabit wireless technology. This combined optimisation and scalability of the control and data plane separates this claim from prior art, which previously had no such control plane computational requirements.

The HPU 102 contains a programmable vector processor array (VPA) 122 which comprises a plurality of vector processor units (VPUs) 123. The number of VPUs can be scaled to reach the desired performance. Scaling VPUs 123 inside the VPA 122 does not require additional controllers.

The HPU also includes a number of fixed function Accelerator Units (AUs) 140a, 140b, and a number of memory to memory DMA (direct memory access) units 135, 136. The VPA, AUs, and DMA units provide the HFUs mentioned above. These units and their controllers can be replicated, however in the description of the following embodiment we have chosen two AU units.

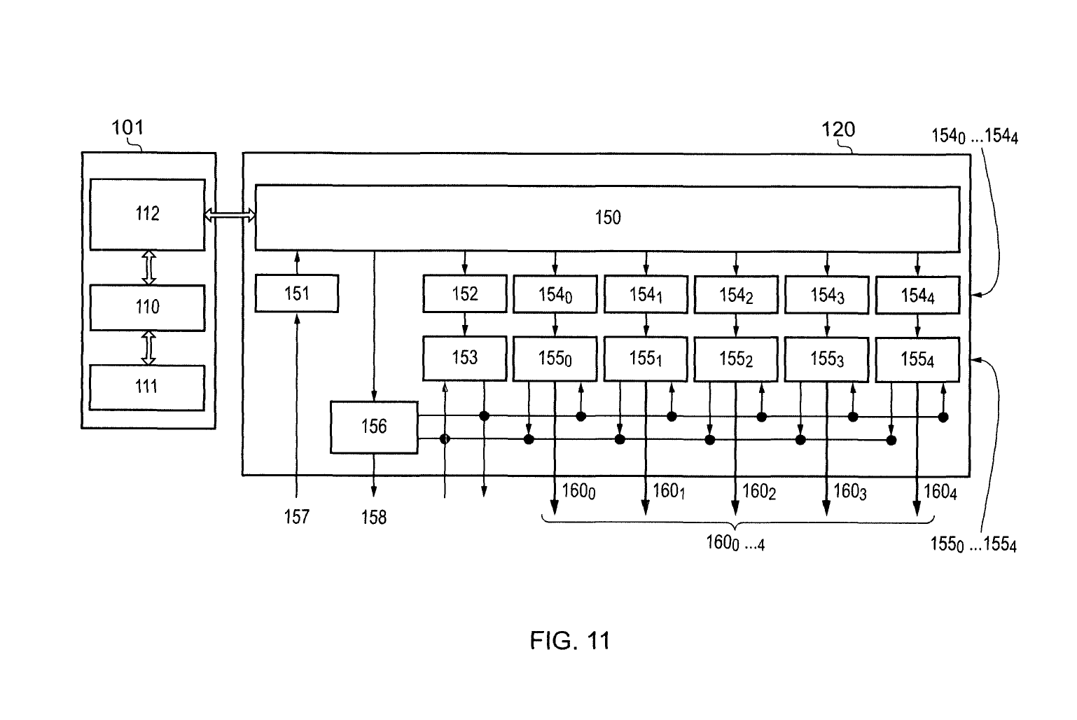

The HCU 120 is shown in more detail in FIG. 11, and comprises an instruction decode unit 150, which is operable to decode (at least partially) instructions and to forward them to one of a number of parallel sequencers 155₀ . . . 155₄, each controlling its own heterogeneous function unit (HFU). Each sequencer has storage 154₀ . . . 154₄ for a number of queued dispatched instructions ready for execution in a local dispatch FIFO buffer. Using a chosen selection from a number of synchronous status signals (SSS), each HFU sequencer can trigger execution of the next queued instructions stored in another HFU dispatch FIFO buffer. Once triggered, multiple instructions will be dispatched from the FIFO and sequenced until another instruction that instructs a wait on the synchronous status signals is parsed, or the FIFO runs empty.

In another embodiment, multiple dispatch FIFO buffers can be used and the choice of triggering of different synchronous status signals can be used to select which buffer is used to dispatch instructions into the respective HFU controller.

Referring back to FIG. 10, the VPA 122 comprises a plurality of vector processor units VPUs 123 arranged in a single instruction multiple data (SIMD) parallel processing architecture. Each VPU 123 comprises a vector processor element (VPE) 130 which includes a plurality of processing elements (PEs) 130₁ . . . 130₄. The PEs in a VPE are arranged in a SIMD within a register configuration (known as a SWAR configuration). The PEs have a high bandwidth data path interconnect function unit so that data items can be exchanged within the SWAR configuration between PEs.

Each VPE 130 is closely coupled to a VPU partitioned data memory (VPU-PDM) 132 subsystem via an optimised high bandwidth VPU network (VPUN) 131. The VPUN 131 is optimised for data movement operations into the localised VPU-PDM 132, and to various other localised networks. The VPUN 132 has allocated sufficient localised bandwidth that it can service additional networks requesting access to the VPU-PDM 132.

One other localised data network is the Accelerator Data Network (ADN) 139 which is provided in order to allow data to be transferred between the VPUs 123 and the AUs 140a, 140b. This network will service all access made to it, however it can be limited by the VPUN 132 availability. Alternatively embodiments can control access to this network using a selected synchronous status signal under program control. The programmer must ensure that unique vector addresses are used so that vector data is managed.

The VPE 130 addresses its local VPU-PDM 132 using an address scheme that is compatible with the overall hierarchical address scheme. The VPE 130 uses a vector SIMD address (VSA) to transfer data with its local VPU-PDM 132. A VSA is supplied to all of the VPUs 123 in the VPA 122, such that all of the VPUs access respective local memory with the same address. A VSA is an internal address which allows addressing of the VPU-PDM only, and does not specify which HFU or VPE is being addressed.

Adding additional address bits to the basic VSA forms a heterogeneous MIMD address (HMA). A HMA identifies a memory location in a particular heterogeneous function unit HFU within the HPU, and again is compatible with the overall system-level addressing scheme. HMAs are used to address specific memory in a specific HFU of a PPU 52.

The VSA and HMA are compatible with the overall system addressing scheme, which means that in order to address a memory location inside an HFU of a particular PPU, the system merely adds PPU-identifying bits to an HMA to produce a system-level address for accessing the memory concerned. The resulting system-level address is unique in the system-level addressing scheme, and is compatible with other system-level addresses, such as those for the local shared memory 56.

Each PPU has a unique address range within the system-level addressing scheme.

Since all the HFUs are uniquely addressable, and have access to all other HFUs and PDMs in the HPU 102, stored data items are uniquely addressable, and, therefore, can be moved amongst these units using direct memory access (DMA) controllers. Every HFU in the HPU has its own DMA controller for this purpose.

DMA units 135, 136 are provided and are arranged such that they may be programmed as the other HPUs by the HCU 120 from instructions dispatched from the SU 101 using instructions specifically targeted at each unit individually. The DMA units 135, 136 can be programmed to add the appropriate address fields so that data can automatically be moved through the hierarchies.

Since the DMA units in the HPU 102 use HMAs they can be instructed by the HCU 120 to move data between the various HFU, PDM and SDN Networks. A parallel pipeline of sequential computational tasks can then be routed seamlessly through the HFUs by executing a series of DMA instructions, followed by execution of appropriate HFU instructions. Thus, these instruction pipelines run autonomously and concurrently.

The DMA units 135, 136 are managed explicitly by the HCU 120 with respective HFU dispatch FIFO buffers (as is the case for the VPU's PDM). The DMA units 13, 136 can be integrated into specific HFUs, such as the accelerator units 140a, 140b, and can share the same dispatch FIFO buffer as that HFU.

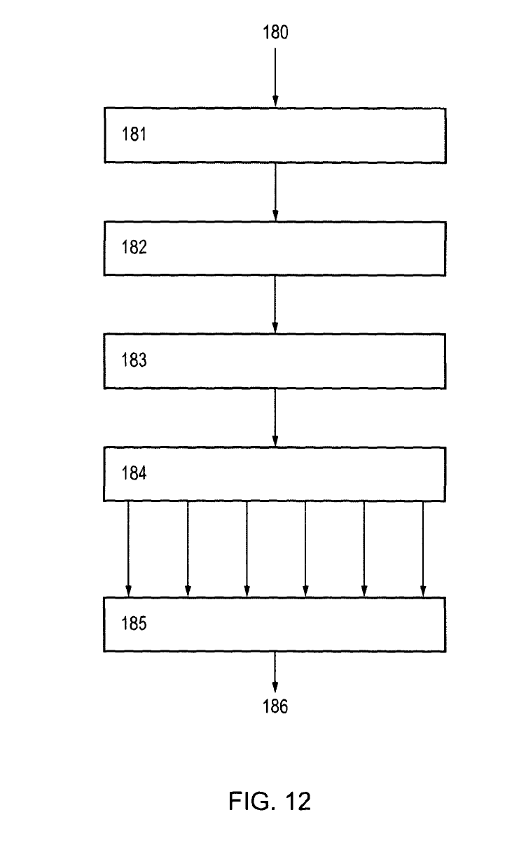

Instructions are issued to the VPA 122 in the form of Very Long Instruction Word (VLIW) microinstructions by a vector micro-coded controller (VMC) within the Instruction decode unit 150 of the HCU 120. The VMC is shown in more detail in FIG. 12, and includes an instruction decoder 181, which receives instruction information 180. The instruction decoder 181 derives an instruction addresses from received instruction information, and passes those derived addresses to an instruction descriptor store 182. The instruction descriptor store 182 uses the received instruction addresses to access a store of instruction descriptors, and passes the descriptors indicated by the received instruction addresses to a code sequencer 183. The code sequencer 183 translates the instruction descriptors into microcode addresses for use by a microcode store 184. The microcode store 184 forms multi-cycle VLIW micro-sequenced instructions defined by the received microcode addresses, and outputs the completed VLIW 186 to the sequencer 155 (FIG. 11) appropriate to the HFU being instructed. The microcode store can be programmed to expand such VLIWs into a long series of repeated vectorised instructions that operate on sequences of addresses in the VPU-PDM 132. The VMC is thus able to extract significant parallel efficiency of control and thereby reduce instruction bandwidth from the PPU SU 101.

In order to ensure that instructions for a specific HFU only execute on data after the previous computation or after a DMA operation has terminated, a selection of synchronous status signals (SS Signals) are provided that are used indicate the status of execution of each HFU to other HFUs. These signals are used to start execution of an instruction that has been halted in another HFU's instruction dispatch FIFO buffer. Thus, one HFU can be caused to await the end of processing of an instruction in another HFU before commencing its own instruction dispatch and processing.

The selection of which synchronous status to use is under program control, and the status is passed as one of the parameters with the instruction for the specific HFU. In each HFU controller, all the synchronous status signals are input into a selectable multiplexer unit to provide a single internal control to the HFU sequencers. Similarly, the sequencer outputs an internal signal, which is selected to drive one of the selected synchronous status signals. These selections are part of the HPU program.

This allows many instructions to be dispatched into HFU dispatch FIFO buffers ahead of the execution of that instruction. This guarantees that each stage of processing will wait until the data is ready for that HFU. Since the vector instructions in the HFUs can last many cycles, it is likely that the instruction dispatch time will be very short compared to the actual execution time. Since many instructions can wait in each HFU dispatch FIFO buffer, the HFUs can optimally execute concurrently without the need for interaction with the SU 101 or any other HFU, once instruction dispatch has been triggered.

A group of synchronous status signals are connected into the SU101 both via interrupt mechanisms via an HPU Status (HPU-STA) 151 or via External Synchronous Signals 153.

This provides synchronisation with SU 101 processes and the HFUs. These are collectively known as SU-SS signals.

Another group of synchronous status signals are connected to the SDN Network and PSN network interfaces. This provides synchronisation across the SoC such that system wide DMAs can be made synchronous with the HPU. This is controlled in controller HFC 153.

Another group of Synchronous Status Signals are connected to programmable timer hardware 153, both local and global to the SoC. This provides a method for accurately timing the start of a processing task and control of DMA of data around the SoC.

Some of the synchronous status signals can be programmed to map onto to the HPU power saving controls (HPU-PSC) 156. These signals are selectively routed to the root clock enable gating clock tree networks of entire HFUs in the HPU such as some or all the VPUs and selectable AUs. These synchronous status signals can be used to switch on and off the clocks to the logic in these units, saving considerable power used in the clock distribution networks.

Alternatively in other power saving modes, these power saving controls are used to control large MTCMOS transistors that are placed in the power supplies of the HFUs. This can turn of power to regions of logic, this can save more power, including any leakage power.

A combination of FFT Accelerator Units, LDPC Accelerator Units and Vector Processor Units are used to offload optimally different sequential stages of computation of an algorithm to the appropriate optimised HFU. Thus the HFU's that constitute the HPU 102 operate automatically and optimally on data in a strict sequential manner described by a software program created using conventional software tools.

The status of the HPU 102 can also be read back using instructions issued through the co-processor interface (CPI) 112. Depending on which instructions are used, various status conditions can be returned to the SU 101 to direct the program flow of the SU 101.

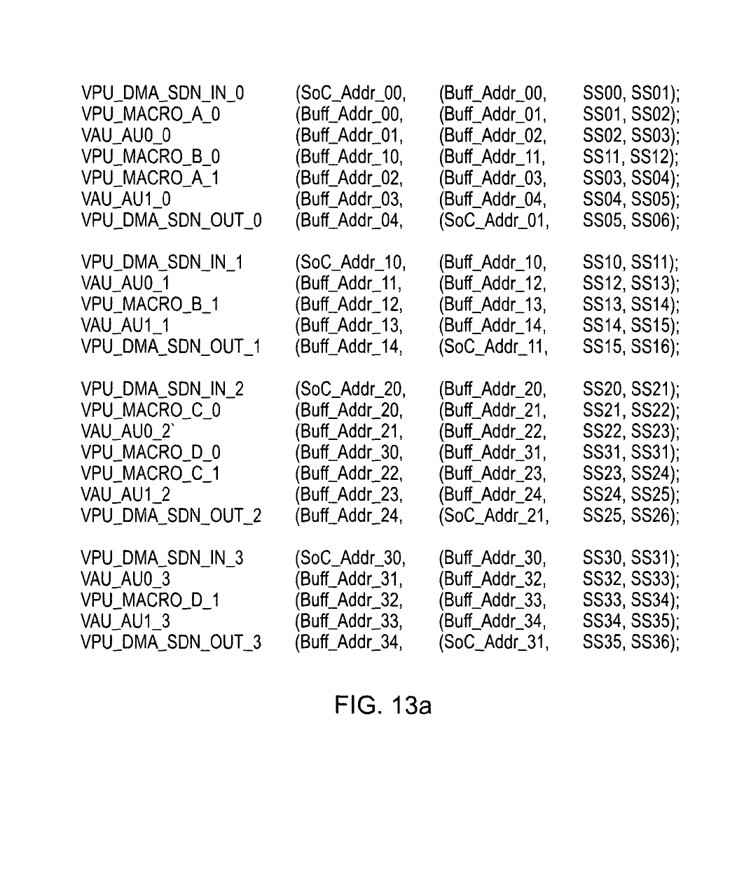

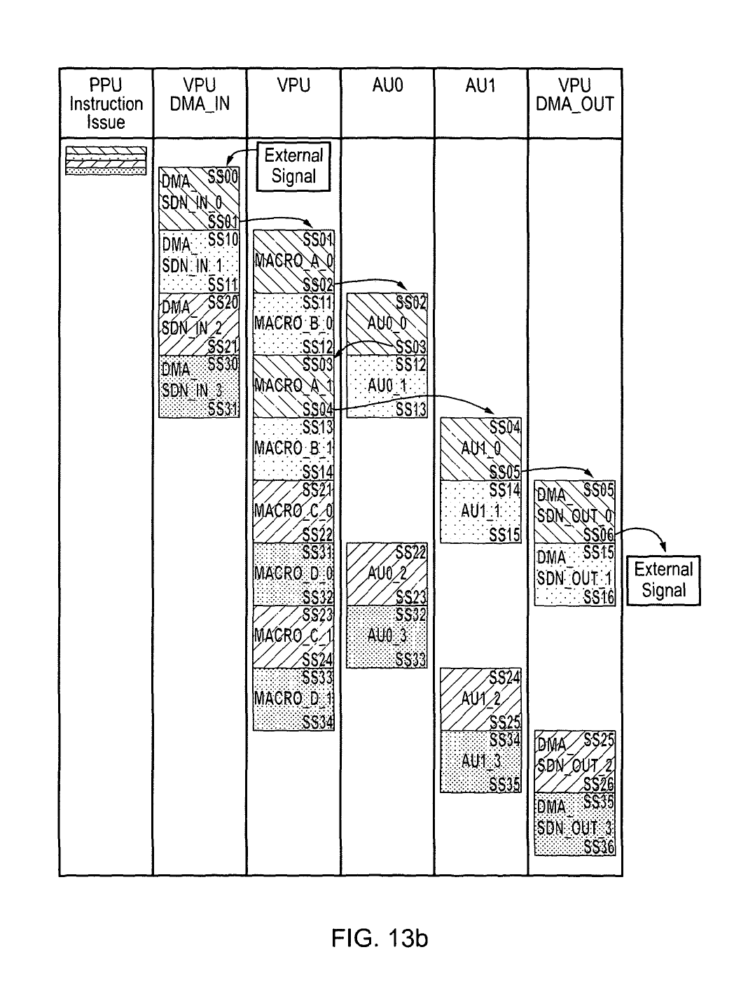

An example illustration of the HPU 102 in operation is shown in FIG. 13B. A typical heterogeneous computation and dataflow operation is shown. The time axis is shown vertically, each block of activity is a vector slot operation which can operate over many 10s or 100s of cycles. HFU units 122, 140a, 140b, 135, 136 status of activity are shown horizontally.

Also illustrated is the subsequent chaining of vector operations, using parallel execution units, utilising the program defined selected synchronous status signals. Each box is named by the reference to the series of instructions in the program of FIG. 13A. In the diagram has the entry synchronous status signal and exit synchronous status signal labelled in the top and bottom right.

The example also illustrates the automated vectored data flow and synchronisation of HFU 122, 140, 135, 136 unit to HFU unit, within the HPU 102, controlled by the program in FIG. 11A. The black arrows indicate the triggering order of the synchronous status signals and hence the control of the flow of data through the HFUs.

The program shown in FIG. 13A, is assembled into a series of instructions, along with addresses and assigned status signals as a contiguous block of data, using development tools during program development.

Once the program is dispatched into the HCU 120, from the SU 101 via the co-processor port, using a block memory operation, the HPU 102 processing is therefore separate and distinct from the SU's 101 own instruction stream. Once dispatched, this frees the SU 101 to proceed without need to service the HPU. This may be many thousands of cycles, which can be used to calculate outer loop parameters such as constants used in equalisation and filtering.

The SU 101 cannot play a part in the subsequent HPU 102 vector execution and dataflow because the rate of dataflow into the HPU 102 from the wider SoC is so high. The SU 101 performance, bandwidths and response latencies are dwarfed by the HPU 102 computational operations, bandwidths and low latency of chained dataflow.

Consequently the performance of the HPU 102 is matched with replications of VPEs 123 in the VPA 122 and high performance throughput and replication of the accelerator units 122, 140a, 140b, 135, 136.

Once instructions are dispatched into the HFC 150, by the SU 101, the HFC decodes instructions fields and loads the instructions into the selected HFU 122, 140a 140b, 135, 136 unit FIFOs 154₀ . . . 154₄, using a pre-defined bit fields. This loading is illustrated by the first block top left of FIG. 13B. An entire HPU 102 program is thus dispatched into the HFU Dispatch FIFOs 154₀ . . . 154₄ before completion or even start of execution in the HPU 102.

In the example, the first operation VPU_DMA_{—} SDN_IN_0 is triggered by an external signal connected to synchronous status signal SSO. This starts a DMA sequencer that streams data into the HMA address Buff_Addr_00 from the system wide SoC vector address SoC_Addr_00. This targets addresses in the VPU-PDM 132 memories. Upon completion the sequencer triggers synchronous status signal SS1.

The triggering of synchronous status signal SS1 is monitored by the VPA 122 dispatch fifo sequencer 155₀ which releases instructions held in the VPA dispatch fifo 154₀. This fifo contains VPU_MACRO_A₀, a sequence of one or more vector instructions that are sequenced into the VPA 122 VMC controller. Hence instructions are executed on the data stored in each of the VPU-PDM 132 memories, in parallel. The resultant processed data is stored at BuffAddr01 in the VPU-PDM 132.

Concurrently with the VPU 122 execution, synchronous status signal SS10 triggers more data streaming from SoC_Addr_10 into the VPU-SDM 132 at address Buff_Addr_10.

Once VPU_MACRO_A_0 finishes, it triggers synchronous status signal SS02, this in turn is monitored by AU0 140a fifo sequencer and releases waiting instructions and addresses in the HFU 140a fifo. Data is streamed from VPU-PDM 132 address Buff_Addr_01 through AU0 140a and back into VPU-PDM 132 at address Buff_Addr_02. Upon termination of this sequence, synchronous status signal SSO3 is triggered. This autonomous chained sequence is illustrated by the black arrows in FIG. 13B.

Thus data flows through the HPU 102 function units under the control of the HPU 102 program using the HCU 120 Synchronous State signals and using the VPU 122 HMA addresses defined in the program. Eventually data is streamed out of the HPU 102 with the VPU_DMA_SDN_OUT instruction to a SoC address defined by SoC_Addr_01 using synchronous state signal SS06.

These sequences then continue as defined in the rest of the program defined in FIG. 13A.

The example shows four phases of similar overlapped dataflow operations. The order of execution is chosen to maximise the utilisation of the VPU 122, as shown by the third column labelled VPU having no pauses in execution as data flows through the HPU 102.

At various phases during execution shown in this example, multiple HFU 122, 140a, 140b, 135, 136 units are shown to run concurrently, autonomously without interaction with SU 101, optimally by minimising latency between one HFU operation completing and another starting and moving data within buss hierarchies of the HPU 102. For example, of the 11 HFU vector execution time slots shown in FIG. 11b, 5 slots have three HFU units running concurrently, and 4 slots have 2 concurrent units running.

Also data flow entering and exiting the HPU 102 is synchronised to external input and output units (not shown) in the wider SoC. If these synchronous signals are delayed or paused the chain of HFU vector processing within the HPU 102 automatically follows in response.

1-21. (canceled)

22. A data processing system comprising:
a control unit;
a plurality of data processing units;
a shared data storage device operable to store data for each of the plurality of data processing units, and to store a task list accessible by each of the data processing units; and
a bus system connected for transferring data between the data processing units, wherein the data processing units each comprise:
a scalar processor device; and
a heterogeneous processor device connected to receive instruction information from the scalar processor, and to receive incoming data, and operable to process incoming data in accordance with received instruction information,
the heterogeneous processor device comprising:
a heterogeneous controller unit connected to receive instruction information from the scalar processor, and operable to output instruction information;
an instruction sequencer connected to receive instruction information from the heterogeneous controller unit, and operable to output a sequence of instructions; and
a plurality of heterogeneous function units, including:
a vector processor array including a plurality of vector processor elements operable to process received data items in accordance with instructions received from the instruction sequencer;
a low-density parity-check (LDPC) decode accelerator unit connected to receive encoded data items from the vector processor array, and operable, under control of the heterogeneous controller unit, to decode such received data items and to transmit decoded data items to the vector processor array; and
a fast Fourier transform (FFT) accelerator unit connected to receive encoded data items from the vector processor array, and operable, under control of the heterogeneous controller unit, to decode such received data items and to transmit decoded data items to the vector processor array,
wherein each data processing unit is operable to access a task descriptor list stored in the shared storage device, to retrieve a task descriptor in such a task descriptor list, and to update that task descriptor in the task descriptor list in dependence upon a state of execution of a task described by the task descriptor, and
wherein the data processing units are operable to store processing information relating to multiple execution phases, and are operable to control entries in the task descriptor list in dependence upon such processing information, and
wherein each data processing unit is operable to enter a low power idle mode following completion of a task by that data processing unit, and operable to be moved into an active processing mode by allocation of a new task by an allocating agent to the data processing unit concerned.

23. The data processing system as claimed in claim 22, wherein the data processing units are operable to store such processing information in the shared storage device.

24. The data processing system as claimed in claim 22, wherein the data processing units are operable to store such processing information in the shared storage device wherein such processing information is stored in the shared storage device appended to task descriptors stored in the task descriptor list.

25. The data processing system as claimed in claim 22, wherein the data processing units are operable to store such processing information in the shared storage device wherein such processing information is stored in the shared storage device separately to task descriptors stored in the task descriptor list.
